(19) United States
(12) Patent Application Publication
(10) Pub. No.: US 2013/0169050 A1
(43) Pub. Date: Jul. 4, 2013

(54) POWER SUPPLY SYSTEM OF WIRELESS COMMUNICATION DEVICE

(71) Applicant: PEGATRON CORPORATION, Taipei City (TW)

(72) Inventor: Chu-An TSENG, TAIPEI CITY (TW)

(73) Assignee: PEGATRON CORPORATION, TAIPEI CITY (TW)

(21) Appl. No.: 13/726,214

(22) Filed: Dec. 23, 2012

(30) Foreign Application Priority Data
Dec. 30, 2011 (TW) 100149959

(51) Int. Cl. H02J 1/00; H02J 7/00

(52) U.S. Cl. CPC H02J 1/00; H02J 7/0068
USPC 307/65

(57) ABSTRACT

A power supply system of a wireless communication device includes a switch, a charging integrated circuit, a solar charging module, a rechargeable battery, and a microprocessor. The switch is electrically connected to the charging integrated circuit when the voltage provided by the solar charging module is higher than or equal to a predetermined value, and at the same time, the solar charging module provides a voltage for the wireless communication device through the charging integrated circuit. The microprocessor is operable to determine whether the voltage provided by the external power source or the PoE is higher than the voltage provided by the rechargeable battery for use in deciding which one of the external power source, the PoE, and the rechargeable battery provides a voltage for the wireless communication device.

### RELATED APPLICATIONS

This application claims priority to Taiwan Application Serial Number 100149959, filed Dec. 30, 2011, which is herein incorporated by reference.

### BACKGROUND

1. Technology Field

The embodiment of the present invention relates generally to electrical communication technology and, more particularly, to a power supply system of a wireless communication device.

2. Description of Related Art

Due to the advances in technology and mobile networks in recent years, the use of mobile internet is becoming increasingly common. For many people in modern society, using a portable device for surfing the internet has become a normal part of everyday life.

However, in the case of Taiwan, as an example, the 3G (3^{rd} Generation) network coverage rate is still insufficient. Therefore, domestic telecommunications operators have planned to increase the number of Wi-Fi hot spots to thirty thousand in 2012 in an effort to meet the demand for mobile Internet. According to estimates, due to the demand for mobile internet, the number of public Wi-Fi hot spots worldwide will be 5.8 million in 2015, and as a consequence, there is expected to be a corresponding increase in the demand for Wi-Fi equipment.

Wi-Fi equipment can be positioned outdoors at a place where there is sufficient sunshine, or indoors at a place where there is sufficient light. Hence, much research and development is being conducted recently with respect to how to optimally utilize the sunshine or light at the location where Wi-Fi equipment is positioned.

### SUMMARY

A power supply system of a wireless communication device is provided, which optimally utilizes the sunshine or light at the location where the power supply system of the wireless communication device is positioned.

One aspect of the embodiment of the present invention is to provide a power supply system for providing a voltage to a wireless communication device. The power supply system comprises a switch, a charging integrated circuit, a solar charging module, a rechargeable battery, and a microprocessor. With respect to the structure of the power supply system, the switch is electrically connected to the wireless communication device,and the wireless communication device is electrically connected to an external power supply or a Power over Ethernet (PoE) equipment through the switch. The charging integrated circuit is electrically connected to the switch, the solar charging module is electrically connected to the charging integrated circuit, the rechargeable battery is electrically connected to the charging integrated circuit, and the microprocessor is electrically connected to the switch and the charging integrated circuit.

With respect to the operation of the power supply system, when the voltage provided by the solar charging module is higher than or equal to a predetermined value, the switch is switched to the charging integrated circuit, the solar charging module provides a voltage to the wireless communication device through the charging integrated circuit, and the solar charging module charges the rechargeable battery through the charging integrated circuit. When the voltage provided by the solar charging module is lower than the predetermined value, the microprocessor determines whether the voltage provided by the external power supply or the PoE equipment is larger than the voltage provided by the rechargeable battery. If the voltage provided by the external power supply or the PoE equipment is larger than the voltage provided by the rechargeable battery, the switch is switched to the external power supply or the PoE equipment, and the external power supply or the PoE equipment provides a voltage to the wireless communication device. If that the voltage provided by the external power supply or the PoE equipment is not larger than the voltage provided by the rechargeable battery, the switch is switched to the charging integrated circuit, and the rechargeable battery provides a voltage to the wireless communication device through the charging integrated circuit.

In one embodiment of the present invention, the charging integrated circuit is operable to detect the voltage provided by the solar charging module. In addition, the microprocessor is operable to determine whether the voltage provided by the solar charging module is larger than or equal to the predetermined value and determine whether the voltage provided by the solar charging module is lower than the predetermined value.

In another embodiment of the present invention, when the voltage provided by the solar charging module is larger than or equal to the predetermined value, the microprocessor controls the switch to switch to the charging integrated circuit and controls the charging integrated circuit to provide the voltage provided by the solar charging module for the wireless communication device. In addition, when the voltage provided by the solar charging module is lower than the predetermined value, the microprocessor controls the switch to switch to the external power supply or the PoE equipment.

In yet another embodiment of the present invention, the number of the rechargeable battery is plural, and the power supply system of the wireless communication device further comprises a time-sharing switch. The time-sharing switch is electrically connected between the rechargeable batteries and the solar charging module, and the power supply system of the wireless communication device charges the rechargeable batteries sequentially by adopting a time-sharing mechanism through the time-sharing switch.

In still another embodiment of the present invention, the number of the rechargeable battery is plural, and the number of the charging integrated circuit is two. When the voltage provided by the solar charging module is larger than or equal to the predetermined value, the solar charging module charges the rechargeable batteries respectively through the charging integrated circuits.

In yet another embodiment of the present invention, the number of the solar charging module is two, and the solar charging modules are electrically connected to the charging integrated circuits respectively. With respect to the operation, when the voltage provided by the solar charging modules is larger than or equal to the predetermined value, the switch is switched to the charging integrated circuits, the solar charging modules provide a voltage to the wireless communication device through the charging integrated circuits respectively, and the solar charging modules charge the rechargeable batteries respectively through the charging integrated circuits.

In still another embodiment of the present invention, the power supply system of the wireless communication device further comprises a direct current to direct current transformer. The charging integrated circuit is electrically connected to the external power supply through the direct current to direct current transformer.

In yet another embodiment of the present invention, the wireless communication device further comprises a direct current to direct current transformer. The direct current to direct current transformer is electrically connected between the charging integrated circuit and the switch.

In still another embodiment of the present invention, when the voltage provided by the solar charging module is lower than the predetermined value, and the microprocessor determines that the voltage provided by the external power supply is larger than the voltage provided by the rechargeable battery, the switch is switched to the external power supply, and the external power supply provides a voltage to the wireless communication device.

In yet another embodiment of the present invention, when the voltage provided by the solar charging module is lower than the predetermined value, and the microprocessor determines that the voltage provided by the PoE equipment is larger than the voltage provided by the rechargeable battery, the switch is switched to the PoE equipment, and the PoE equipment provides a voltage to the wireless communication device.

As a result, the embodiments of the present invention provide the power supply system of the wireless communication device, which can optimally utilize electricity generated from the sunshine or indoor lighting properly to thereby achieve the goal of saving energy. Moreover, when the amount of sunshine or indoor lighting is insufficient, the power supply system can receive electricity of the external power supply or PoE equipment. Hence, the power supply system will not experience an interruption in electricity supplied thereto. In addition, when the power supply system is in a state where there is an insufficient amount or no sunshine or indoor lighting, the power supply system can make use of the rechargeable battery which is charged in advance to provide electricity for the power supply system.

In addition, when the power supply system is in a state where the amount of sunshine or indoor lighting is sufficient, the power supply system can employ a time-sharing mechanism to charge the rechargeable batteries. Therefore, when the power supply system is in a state where it is receiving an insufficient amount of or no sunshine or indoor lighting, the power supply system can make use of the rechargeable batteries which are charged in advance to provide electricity for the power supply system, such that the dependability of using the rechargeable batteries to provide electricity by the power supply system can be promoted. Moreover, through such a configuration and operation, the reliance of the power supply system on the use of the electricity provided by the external power supply or PoE equipment can be decreased to thereby further work favorably toward the goal of saving energy.

### BRIEF DESCRIPTION OF THE DRAWINGS

The invention can be more fully understood by reading the following detailed description of the embodiments, with reference made to the accompanying drawings as follows:

FIG. 1 schematically shows a circuit block diagram of a power supply system of a wireless communication device according to embodiments of the present invention.

FIG. 2 schematically shows a circuit block diagram of a power supply system of a wireless communication device according to embodiments of the present invention.

FIG. 3 schematically shows a circuit block diagram of a power supply system of a wireless communication device according to embodiments of the present invention.

FIG. 4 schematically shows a circuit block diagram of a power supply system of a wireless communication device according to embodiments of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a,” and “the” includes plural reference unless the context clearly dictates otherwise. Also, as used in the description herein and throughout the claims that follow, the meaning of “in” includes “in” and “on” unless the context clearly dictates otherwise.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. The use of examples anywhere in this specification, including examples of any terms discussed herein, is illustrative only, and in no way limits the scope and meaning of the invention or of any exemplified term. Like e, the invention is not limited to various embodiments given in this specification.

As used herein, “around,” “about” or “approximately” shall generally mean within 20 percent, preferably within 10 percent, and more preferably within 5 percent of a given value or range. Numerical quantities given herein are approximate, meaning that the term “around,” “about” or “approximately can be inferred if not expressly stated.

As used herein, the terms “comprising,” “including,” “having,” “containing,” “involving,” and the like are to be understood to be open-ended, i.e., to mean including but not limited to.

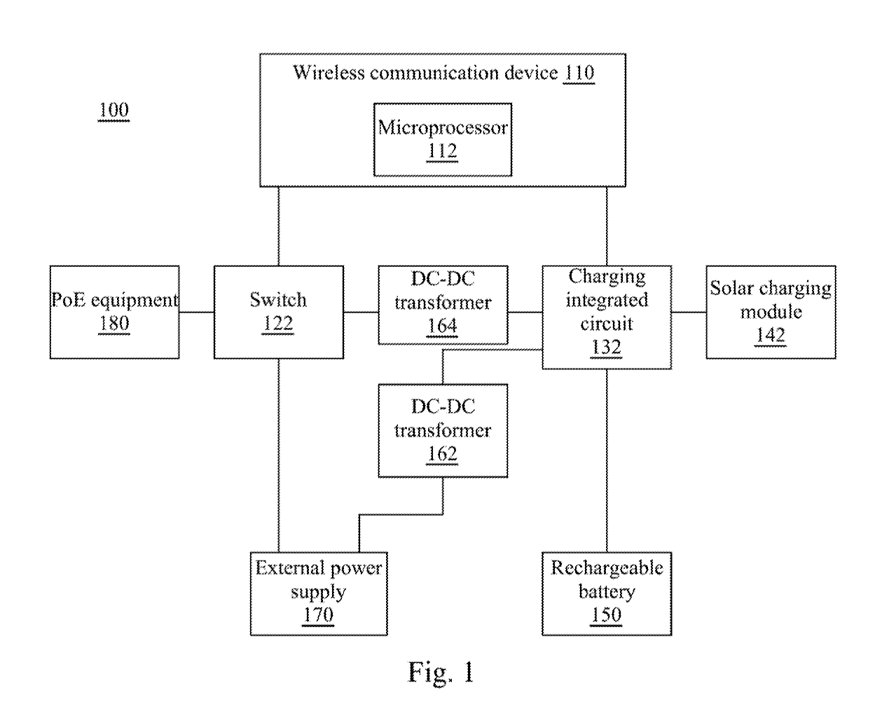

FIG. 1 schematically shows a circuit block diagram of a power supply system 100 of a wireless communication device 110 according to embodiments of the present invention. As shown in FIG. 1, the power supply system 100 is operable to provide a voltage to the wireless communication device 110, and the power supply system 100 comprises a switch 122, a direct current to direct current transformer 164, a charging integrated circuit 132, a solar charging module 142, a rechargeable battery 150, a microprocessor 112, and a direct current to direct current transformer 162. It is noted that the microprocessor 112 can be selectively disposed in the wireless communication device 110 or in other electrical elements depending on actual requirements. In some embodiments, the microprocessor 112 can be independently disposed in the power supply system 100 as one of the electrical elements thereof. Hence, the disposition as shown in FIG. 1 is merely used to depict an embodiment of the present invention, and the scope of the present invention is not intended to be limited in this regard.

With respect to the structure of the power supply system 100, the switch 122 is electrically connected to the wireless communication device 110, and the wireless communication device 110 is electrically connected to an external power supply 170 and a Power over Ethernet (PoE) equipment 180 through the switch 122. The direct current to direct current transformer 164 is electrically connected to the switch 122, and the charging integrated circuit 132 is electrically connected to the direct current to direct current transformer 164. The solar charging module 142, the direct current to direct current transformer 162, and the rechargeable battery 150 are all electrically connected to the charging integrated circuit 132. Furthermore, the charging integrated circuit 132 is electrically connected to the external power supply 170 through the direct current to direct current transformer 162.

With respect to the operation of the power supply system 100, the charging integrated circuit 132 is operable to detect the voltage provided by the solar charging module 142. Subsequently, the microprocessor 112 is operable to determine whether the voltage provided by the solar charging module 142 is larger than or equal to a predetermined value. When the voltage provided by the solar charging module 142 is larger than or equal to the predetermined value, the microprocessor 112 controls the switch 122 to switch to a circuit path that includes the charging integrated circuit 132 and controls the charging integrated circuit 132 to provide the voltage provided by the solar charging module 142 for the wireless communication device 110. Simultaneously, the solar charging module 142 charges the rechargeable battery 150 through the charging integrated circuit 132. Those skilled in the art can selectively set the predetermined value depending on actual requirements. For example, the predetermined value can be set according to the conditions of the place in which the power supply system of the wireless communication device 100 is disposed.

In addition, the microprocessor 112 determines whether the voltage provided by the solar charging module 142 and detected by the solar charging module 142 is lower than the predetermined value. Subsequently, when the voltage provided by the solar charging module 142 is lower than the predetermined value, the microprocessor 112 determines whether the voltage provided by the external power supply 170 or the PoE equipment 180 is larger than the voltage provided by the rechargeable battery 150. If the voltage provided by the external power supply 170 or the PoE equipment 180 is larger than the voltage provided by the rechargeable battery 150, the microprocessor 112 controls the switch 122 to switch to the external power supply 170 or the PoE equipment 180, and accordingly, the external power supply 170 or the PoE equipment 180 is used to provide a voltage for the wireless communication device 110.

Furthermore, if the voltage provided by the external power supply 170 or the PoE equipment 180 is not larger than the voltage provided by the rechargeable battery 150, the switch 122 is switched to the charging integrated circuit 132, and the rechargeable battery 150 provides a voltage for the wireless communication device 110 through the charging integrated circuit 132.

Specifically, in the case where the external power supply 170 is used to provide a voltage for the wireless communication device 110, when the microprocessor 112 determines that the voltage provided by the solar charging module 142 is lower than the predetermined value, the microprocessor 112 is further used to determine whether the voltage provided by the external power supply 170 is larger than the voltage provided by the rechargeable battery 150. Hence, if the voltage of the external power supply 170 is larger than the voltage of the rechargeable battery 150, the external power supply 170 is used to provide a voltage for the wireless communication device 110. At the same time, the voltage provided by the external power supply 170 can be reduced by the direct current to direct current transformer 162 to conform to the requirements of the rechargeable battery 150, and the charging integrated circuit 132 is used to charge the rechargeable battery 150. In this embodiment, the direct current to direct current transformer 164 is operable to reduce the voltage provided by the charging integrated circuit 132 to conform to the requirements of the wireless communication device 110.

On the other hand, if the microprocessor 112 determines that the voltage provided by the external power supply 170 is not larger than the voltage of the rechargeable battery 150, the microprocessor 112 controls the switch 122 to switch to the circuit path that includes the charging integrated circuit 132 such that the rechargeable battery 150 provides a voltage to the wireless communication device 110 through the charging integrated circuit 132, the direct current to direct current transformer 164, and the switch 122.

The power supply system 100 of the wireless communication device 110 is disposed at a place where there is sufficient sunshine or indoor lighting. When the sunshine or indoor lighting illuminates the solar charging module 142, the voltage generated by the solar charging module 142 is larger than or equal to the predetermined value,and therefore, the solar charging module 142 is used to provide electricity. On the other hand, when the sunshine or indoor lighting does not illuminate the solar charging module 142, the voltage generated by the solar charging module 142 is lower than the predetermined value, and therefore, the external power supply 170 or the PoE equipment 180 will provide electricity.

Furthermore, when the power supply system of the wireless communication device 100 is in a state where it is receiving an insufficient amount of or no sunshine or indoor lighting, the power supply system 100 can make use of the rechargeable battery 150 which is charged in advance to provide electricity. Hence, the goal of saving energy is further achieved.

As a result, the power supply system 100 of the embodiments of the present invention can employ electricity generated by sunshine or indoor lighting to thereby achieve the goal of saving energy. However, when there is an insufficient amount of or no sunshine or indoor lighting, the power supply system 100 can still receive electricity from the external power supply 170 or the PoE equipment 180. Hence, there will be no interruption in the electricity provided for the power supply system 100.

In one embodiment, when the voltage provided by the solar charging module 142 is lower than the predetermined value, and the microprocessor 112 determines that the voltage provided by the external power supply 170 is larger than the voltage provided by the rechargeable battery 150, the switch 122 is switched to the external power supply 170, and accordingly, the external power supply 170 provides a voltage to the wireless communication device 110.

In another embodiment, when the voltage provided by the solar charging module 142 is lower than the predetermined value, and the microprocessor 112 determines that the voltage provided by the PoE equipment 180 is larger than the voltage provided by the rechargeable battery 150, the switch 122 is switched to the PoE equipment 180, and accordingly, the PoE equipment 180 provides a voltage to the wireless communication device 110.

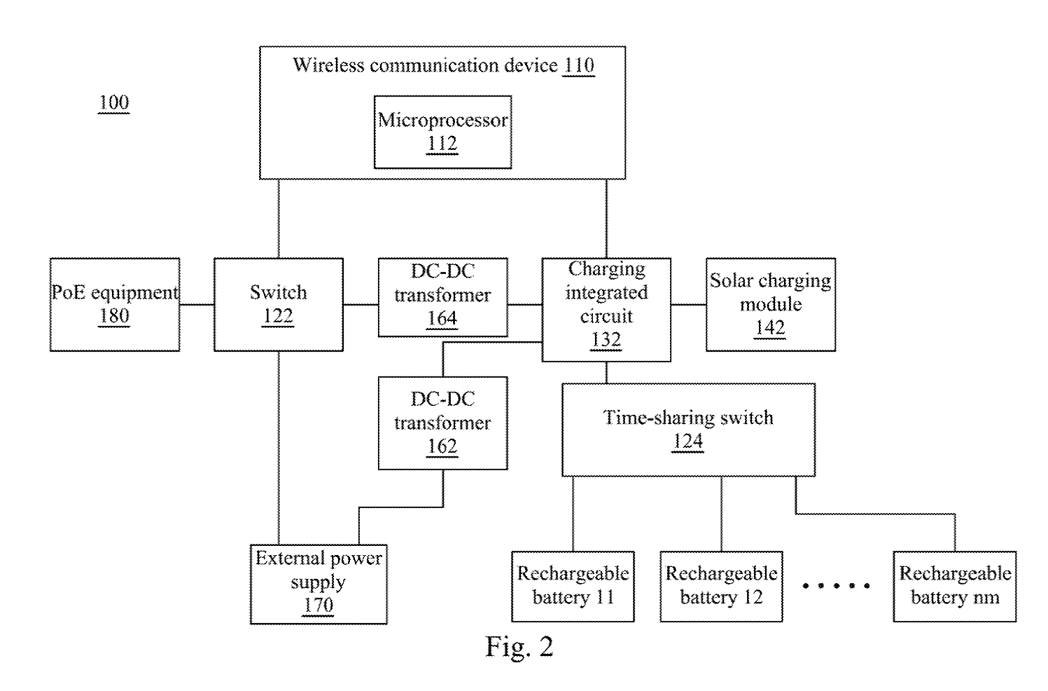

FIG. 2 schematically shows a circuit block diagram of a power supply system 100 of a wireless communication device 110 according to embodiments of the present invention. Compared with the power supply system 100 as shown in FIG. 1, in the embodiment shown in FIG. 2, there are a plurality of rechargeable batteries 11˜nm in the power supply system 100, and the power supply system 100 further comprises a time-sharing switch 124. The time-sharing switch 124 is electrically connected between the rechargeable batteries 11˜nm and the solar charging module 142. The time-sharing switch 124 employs a time-sharing mechanism to charge the rechargeable batteries 11˜nm in turn.

For example, the time-sharing mechanism employed by the time-sharing switch 124 is used to charge the rechargeable battery 11 for 10 seconds, the rechargeable battery 12 for a subsequent 10 seconds, the rechargeable battery 13 for 10 seconds after that, and so on. That is to say, the solar charging module 142 charges the rechargeable batteries 11˜nm in turn by operation of the time-sharing switch 124. However, the scope of the embodiment of the present invention is not intended to be limited in this regard, and those skilled in the art can selectively adopt an appropriate mechanism depending on actual requirements.

As a result, when the power supply system 100 is in a state where it is receiving a sufficient amount of sunshine or indoor lighting, the power supply system 100 can employ a time-sharing mechanism to charge the rechargeable batteries 11˜nm. Therefore, when the power supply system 100 is in a state where it is receiving an insufficient amount of or no sunshine or indoor lighting, the power supply system 100 can make use of the rechargeable batteries 11˜nm which are charged in advance to provide electricity for the power supply system 100, such that the dependability of using the rechargeable batteries 11˜nm to provide electricity by the power supply system 100 can be promoted. Moreover, through such a configuration and operation, the possibility of the power supply system 100 utilizing the electricity provided by the external power supply 170 or the PoE equipment 180 can be decreased to thereby further work favorably toward the goal of energy saving.

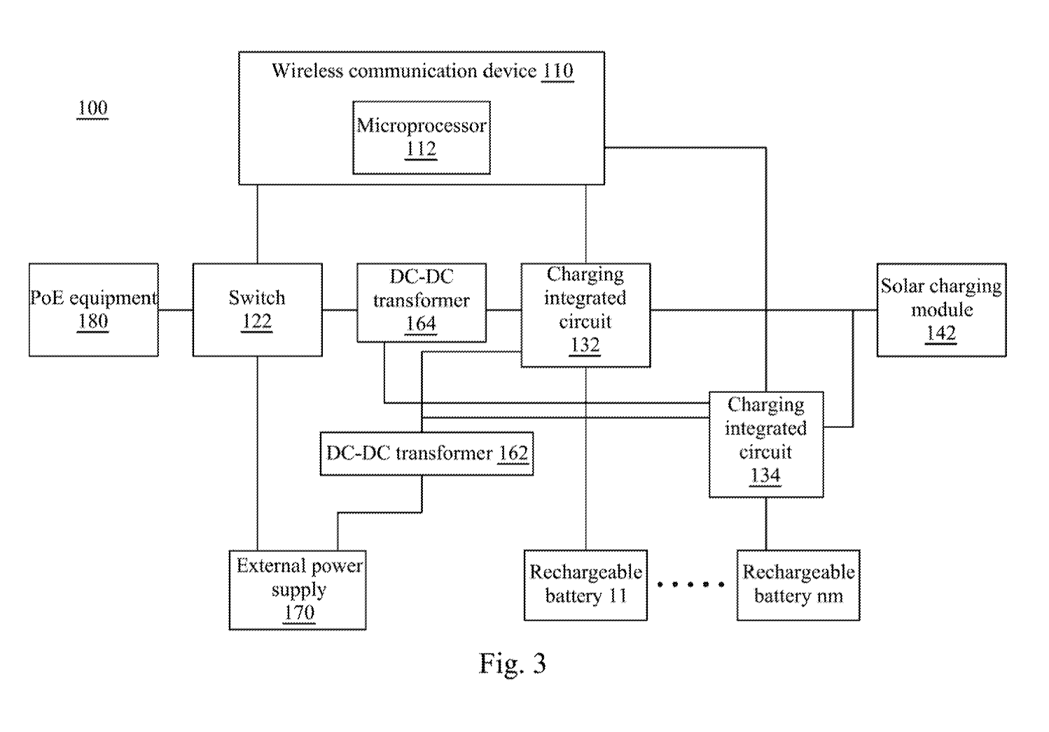

FIG. 3 schematically shows a circuit block diagram of a power supply system 100 of a wireless communication device 110 according to embodiments of the present invention. Compared with the power supply system 100 as shown in FIG. 1, in the embodiment shown in FIG. 3, there are a plurality of rechargeable batteries 11˜nm in the power supply system 100 and the power supply system 100 further comprises a charging integrated circuit 134. With respect to the operation of the power supply system 100, when the voltage provided by the solar charging module 142 is larger than or equal to a predetermined value, the solar charging module 142 charges the rechargeable batteries 11˜nm respectively through the charging integrated circuits 132, 134.

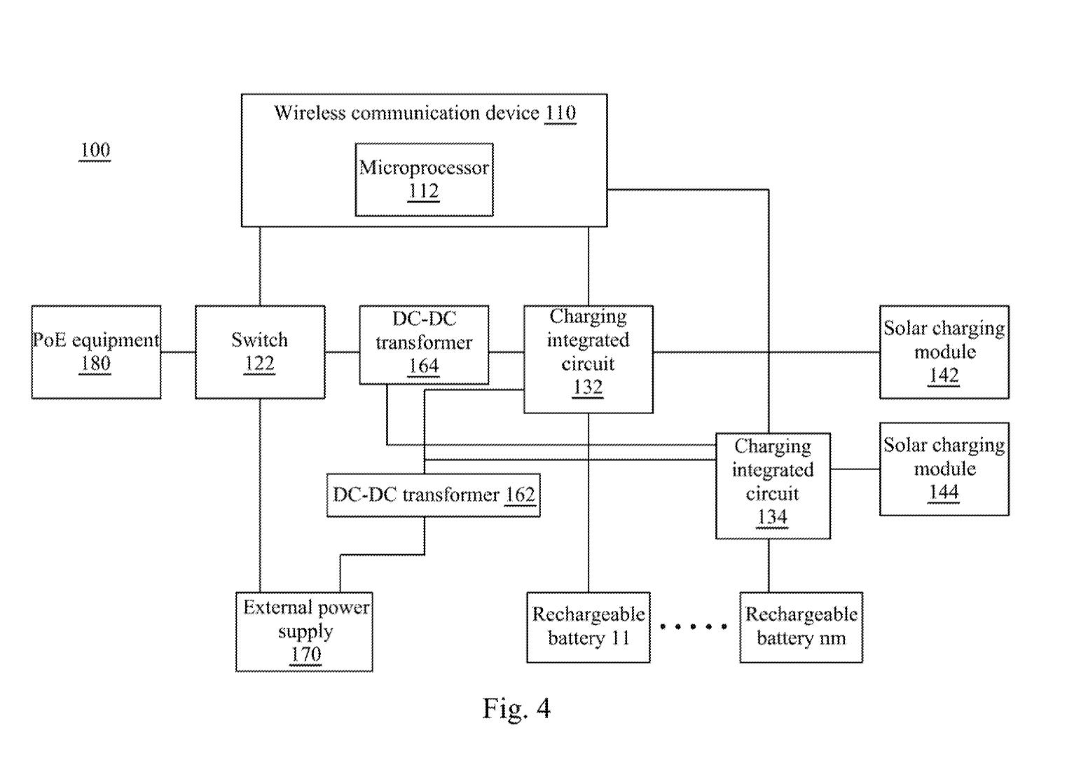

FIG. 4 schematically shows a circuit block diagram of a power supply system 100 of a wireless communication device 110 according to embodiments of the present invention. Compared with the power supply system 100 as shown in FIG. 3, in the embodiment shown in FIG. 4, the power supply system 100 further comprises a solar charging module 144.

With respect to the structure of the power supply system 100, the solar charging modules 142, 144 are respectively electrically connected to the charging integrated circuits 132, 134. When the voltage provided by the solar charging modules 142, 144 is larger than or equal to a predetermined value, the switch 122 is switched to the charging integrated circuits 132, 134, and accordingly, the solar charging modules 142, 144 provide a voltage for the wireless communication device 110 respectively through the charging integrated circuits 132, 134, and the solar charging modules 142, 144 respectively charge the rechargeable batteries 11˜nm through the charging integrated circuits 132, 134.

As a result of the fact that the power supply system 100 comprises more solar charging modules 142, 144, when the sunshine or indoor lighting is sufficient, the solar charging modules 142, 144 can provide more electricity to the power supply system 100 and thereby fully charge the rechargeable batteries 11 nm faster.

In view of the foregoing embodiments of the present invention, many advantages of the present invention are now apparent. The power supply system 100 according to the embodiments of the present invention can optimally utilize electricity generated from sunshine or indoor lighting to thereby achieve the goal of saving energy. Moreover, when the amount of sunshine or indoor lighting is insufficient, the power supply system 100 can receive electricity from the external power supply 170 or the PoE equipment 180. Hence, the power supply system 100 will not experience an interruption in the electricity supplied thereto. In addition, when the power supply system 100 is in a state where there is an insufficient amount of or no sunshine or indoor lighting, the power supply system 100 can make use of the rechargeable battery 150 which is charged in advance to provide electricity for the power supply system 100.

In addition, when the power supply system 100 is in a state where the amount of sunshine or indoor lighting is sufficient, the power supply system 100 can employ the time-sharing mechanism to charge the rechargeable batteries 11˜nm. Therefore, when the power supply system 100 is in a state where it is receiving an insufficient amount of or no sunshine or indoor lighting, the power supply system 100 can make use of the rechargeable batteries 11˜nm which are charged in advance to provide electricity for the power supply system 100, such that the dependability of using the rechargeable batteries 11˜nm to provide electricity by the power supply system 100 can be promoted. Moreover, through such a configuration and operation, the reliance of the power supply system 100 on the use of the electricity provided by the external power supply 170 or the PoE equipment 180 can be decreased to thereby further work favorably toward the goal of saving energy.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention, and the scope thereof is determined by the claims that follow.

What is claimed is:

1. A power supply system or providing a voltage to a wireless communication device, comprising:
a switch electrically connected to the wireless communication device, wherein the wireless communication device is electrically connected to an external power supply or a Power over Ethernet (PoE) equipment through the switch;
a charging integrated circuit electrically connected to the switch;
a solar charging module electrically connected to the charging integrated circuit;
a rechargeable battery electrically connected to the charging integrated circuit; and
a microprocessor electrically connected to the switch and the charging integrated circuit,
wherein when the voltage provided by the solar charging module is higher than or equal to a predetermined value, the switch is switched to the charging integrated circuit, the solar charging module provides a voltage to the wireless communication device through the charging integrated circuit, and the solar charging module charges the rechargeable battery through the charging integrated circuit,
wherein when the voltage provided by the solar charging module is lower than the predetermined value, the microprocessor determines whether the voltage provided by the external power supply or the PoE equipment is larger than the voltage provided by the rechargeable battery,
if the voltage provided by the external power supply or the PoE equipment is larger than the voltage provided by the rechargeable battery, the switch is switched to the external power supply or the PoE equipment, and the external power supply or the PoE equipment provides a voltage to the wireless communication device,
if the voltage provided by the external power supply or the PoE equipment is not larger than the voltage provided by the rechargeable battery, the switch is switched to the charging integrated circuit, and the rechargeable battery provides a voltage to the wireless communication device through the charging integrated circuit.

2. The power supply system according to claim 1, wherein the charging integrated circuit is operable to detect the voltage provided by the solar charging module, and the microprocessor is operable to determine whether the voltage provided by the solar charging module is larger than or equal to the predetermined value and determine whether the voltage provided by the solar charging module is lower than the predetermined value.

3. The power supply system according to claim 2, wherein when the voltage provided by the solar charging module is larger than or equal to the predetermined value, the microprocessor controls the switch to switch to the charging integrated circuit and controls the charging integrated circuit to provide the voltage provided by the solar charging module for the wireless communication device, wherein when the voltage provided by the solar charging module is lower than the predetermined value, the microprocessor controls the switch to switch to the external power supply or the P E equipment.

4. The power supply system according to claim 1, wherein the number of the rechargeable battery is plural, and the power supply system of the wireless communication device further comprises a time-sharing switch, wherein the time-sharing switch is electrically connected between the rechargeable batteries and the solar charging module, and the power supply system of the wireless communication device charges the rechargeable batteries sequentially by adopting a time-sharing mechanism through the time-sharing switch.

5. The power supply system according to claim 1, wherein the number of the rechargeable battery is plural, and the number of the charging integrated circuit is two, wherein when the voltage provided by the solar charging module is larger than or equal to the predetermined value, the solar charging module charges the rechargeable batteries respectively through the charging integrated circuits.

6. The power supply system according to claim 5, wherein the number of the solar charging module is two, and the solar charging modules are electrically connected' to the charging integrated circuits respectively, wherein when the voltage provided by the solar charging modules is larger than or equal to the predetermined value, the switch is switched to the charging integrated circuits, the solar charging modules provide a voltage to the wireless communication device through the charging integrated circuits respectively, and the solar charging modules charge the rechargeable batteries respectively through the charging integrated circuits.

7. The power supply system according to claim 1, further comprising:
a direct current to direct current transformer, wherein the charging integrated circuit is electrically connected to the external power supply through the direct current to direct current transformer.

8. The power supply system according to claim 1, further comprising:
a direct current to direct current transformer electrically connected between the charging integrated circuit and the switch.

9. The power supply system according to claim 1, wherein when the voltage provided by the solar charging module is lower than the predetermined value, and the microprocessor determines that the voltage provided by the external power supply is larger than the voltage provided by the rechargeable battery, the switch is switched to the external power supply, and the external supply provides a voltage to the wireless communication device.

10. The power supply system according to claim 1, wherein when the voltage provided by the solar charging module is lower than the predetermined value, and the microprocessor determines that the voltage provided by the PoE equipment is larger than the voltage provided by the rechargeable battery, the switch is switched to the PoE equipment, and the PoE equipment provides a voltage to the wireless communication device.
